(19) United States
(12) Patent Application Publication
(10) Pub. No.: US 2006/0229087 A1
(43) Pub. Date: Oct. 12, 2006

(54) Location-based cell determination for mobile communication networks

(75) Inventors: John P. Davis III, Marietta, GA (US); Marvin U. Fuller JR., Cumming, GA (US)

Correspondence Address: GARDNER GROFF SANTOS & GREENWALD, P.C., 2018 POWERS FERRY ROAD, SUITE 800, ATLANTA, GA, 30339, US

(73) Assignee: Cingular Wireless, LLC

(21) Appl. No.: 11/103,721

(22) Filed: Apr. 12, 2005

(51) Int. Cl. H04Q 7/20

(52) U.S. Cl. 455/456.1; 455/433; 455/435.1

(57) ABSTRACT

The geographic location of user equipment operating in a cellular communication network is determined, and handover is performed at least in part in response to the geographic location of the user equipment.

### FIELD OF THE INVENTION

The present invention relates generally to cellular communication networks and, more specifically, to the handoff or handover of a mobile handset or other mobile communication device from one cell to another.

### DESCRIPTION OF THE RELATED ART

“Handoff” or “handover” is a term that refers to the process or method by which a cellular communication network maintains a user operating a mobile telephone handset, wireless data device, or other such mobile user equipment (UE), in wireless (radio) communication as the user moves from one geographic area served by the network to another. A cellular communication network comprises numerous adjacent cells, each of which includes a base station or base transceiver station (BTS) that can serve, i.e., communicate with, any active UE within a certain reception range or range within which good signal quality and strength can be expected. The cells are thus essentially circular in shape, with their diameters defined by this range, and may overlap adjacent cells to some extent. Nevertheless, for convenience cells are typically graphically represented on geographic network maps as polygons, most commonly hexagons. As the UE moves away from the BTS, i.e., toward the cell edge or boundary, the signals communicated between the UE and the BTS fade or otherwise degrade. One or more network entities monitor signal quality, strength or similar measurement of how “good” a signal is between the UE and each of the various cells in the vicinity of the UE. The measured quantities are compared with one another to identify the cell with which the UE communicates the best signal. If it is determined that another cell would communicate a better signal than the cell currently serving the UE, the UE is handed over from the then-serving cell to the other cell. That is, the cell to which the network hands over the UE begins serving the UE, and the cell from which the network hands over the UE ceases to serve the UE. Such a handover may occur again from time to time as the UE moves about.

The network entity that monitors the signals and makes the decision whether to hand over a UE to a different cell depends upon the network type, but in many networks the entity is known as a base station controller. (An analogous network entity is known as a radio network controller (RNC) in the context of other types of networks. For purposes of this patent specification, the term “base station controller” (BSC) includes within its scope not only a BSC but also an RNC and all such other analogous entities.) The BSC includes processing logic that performs an algorithm involving the above-mentioned signal comparison. Various handover algorithms are known in the art. One well-known example of such an algorithm is known as Mobile Assisted HandOff (MAHO). In the MAHO algorithm, signal strength and quality of the voice signals the UE is receiving from its serving cell, plus the control signals of neighboring cells, are compared with each other to determine the best cell to serve the UE.

The cell to which the BSC hands over the UE is usually adjacent to the cell serving the UE prior to the handover because an adjacent cell is usually able to communicate a better signal with the UE as the UE moves into it than a more distant cell. Nevertheless, although it may be unusual or atypical, the BSC quite often hands over a UE to a non-adjacent cell. A non-adjacent cell will often, at least momentarily, appear (from the perspective of the handover algorithm) to communicate the best signal, due to variations among the compared signals caused by multipath reflection or other propagation effects arising from terrain features, made-made features such as tunnels, buildings and other structures, and environmental factors. For example, the signals communicated between a UE in a car that a user is driving through a tunnel and the geographically nearest BTS may temporarily be degraded to the point that better signals are communicated between the UE and a more distant BTS. One may speculate in the example scenario that perhaps, while the tunnel shields the UE from good communication with the nearest BTS, the antenna of the more distant BTS is momentarily favorably aligned in a line-of-sight with the tunnel entrance. In any event, in such circumstances, handing over the UE to the more distant cell often results in a dropped call, while maintaining communication with the cell then serving the UE and not performing a handover would likely result in momentarily degraded communication but not total dropping of the call.

Accordingly, it would be desirable to provide an enhancement to existing handover methods that results in fewer dropped calls than conventional handover methods. It is to such a method and system that the present invention is directed.

### SUMMARY OF THE INVENTION

The present invention relates to a method and system in which the geographic location of a voice handset, wireless data device or other user equipment (UE) operating in a cellular communication network is determined, and handover is performed at least in part in response to the geographic location of the UE.

Handover can be performed partly in response to the geographic location of the UE and partly in response to signal measurements, such as signal strength and quality. In one exemplary handover method, the UE is handed over to the cell in which it is located unless the signals received from the UE by the serving cell are better (e.g., in terms of strength and quality) by predetermined margins than those received from the UE by the serving cell. In another exemplary handover method, weights are assigned to factors, such as whether the UE is located in the serving cell, the strength of the signals received from the UE by the serving cell, and the quality of the signals received from the UE by the serving cell. The determination of whether to hand over the UE can depend upon the combined weighted factors. In still other embodiments, a conventional handover algorithm, such as MAHO, can be modified in accordance with the present invention to more heavily weight a cell nearer to the UE than a cell farther from the UE. The weighting can take into account the distance between the UE and the center of the cell (i.e., the BTS location) in which the UE is located or, alternatively, it can take into account only whether the UE is located in the cell. In an example of the former type of weighting, the location of a UE nearly in the center of a cell can carry a weight sufficient to ensure that that cell is selected to serve the UE almost regardless of signal measurements, whereas the location of a UE on a boundary between two cells can carry less weight in the selection algorithm than signal measurements.

Although in the above-described embodiments of the invention the cell selected to serve a UE is selected partly in response to the geographic location of the UE and partly in response to signal measurements, in other embodiments of the invention the cell in which the UE is located can be selected to serve the UE entirely in response to the geographic location of the UE, i.e., without regard to signal measurements or other factors. In other words, if the cell in which the UE is located is not serving the UE, the UE is handed over to the cell in which it is located. In still other embodiments of the invention the cell can be selected in whole or part in response to a predictive algorithm in which the future location of the UE is estimated based upon the path in which the UE has been moving, and the handover algorithm selects (or, in embodiments that take signal measurements or other factors into account, more heavily favors) a cell into which the UE is predicted to be about to move.

Any suitable means known in the art for determining the location of a UE or similar mobile object can be used, such as Assisted GPS (A-GPS), Time Difference of Arrival (TDOA), Angle of Arrival (AOA), etc. Conventionally, such means are used in some cellular communication networks to determine the location of a caller in an emergency situation (e.g., the “911” system used in the United States) so that assistance can be dispatched. Such means are referred to in the context of certain types of networks as a Serving Mobile Location Center (SMLC). Thus, in cellular networks having an SMLC or similar means for determining the location of a UE, the location information can be provided to the handover algorithm of the present invention.

The present invention is useful in any cellular communication network regardless of its type (e.g., CDMA, TDMA, GSM, etc.), structure and standards by which it operates. The following detailed description provides examples of how the invention can preferably be embodied in many common cellular networks.

### BRIEF DESCRIPTION OF THE DRAWINGS

FIG. 1 is a network diagram, illustrating a generalized cellular communication network in accordance with one embodiment of the invention.

FIG. 2 illustrates a mobile handset or other user equipment (UE) being served in a cellular communication network by a cell in which the UE is not geographically located.

FIG. 3 illustrates a mobile handset or other user equipment (UE) being served in a cellular communication network by the cell in which the UE is geographically located.

FIG. 4 is a flow diagram, illustrating a method for determining the location of a UE in the network of FIG. 1 and performing handover.

FIG. 5 is another flow diagram, illustrating an example of a handover method in the network of FIG. 1.

FIG. 6A is another flow diagram, illustrating another example of a handover method in the network of FIG. 1.

FIG. 6B is a continuation of the flow diagram of FIG. 6A.

### DETAILED DESCRIPTION

In the following description, like reference numerals indicate like components to enhance the understanding of the invention through the description of the drawings. Also, although specific features, configurations, arrangements and steps are discussed below, it should be understood that such specificity is for illustrative purposes only. A person skilled in the relevant art will recognize that other features, configurations, arrangements and steps are useful without departing from the spirit and scope of the invention.

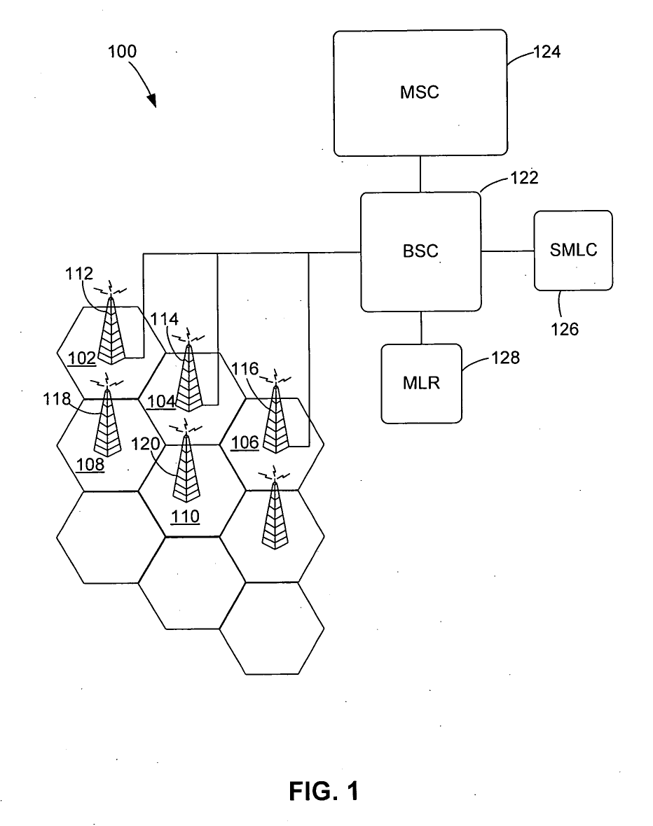

A cellular communication network 100 of the GSM type is illustrated in generalized form in FIG. 1. Although a GSM network is illustrated as an example, persons skilled in the art to which the present invention relates will readily understand how to embody the present invention in any other type of cellular communication network, such as CDMA, TDMA, etc., in view of this example. Network 100 includes a number of cells 102, 104, 106, 108, 110, etc., each of which is defined by a base transceiver station (BTS) 112, 114, 116, 118, 120, etc. The term “cell” is often used in the art to refer to both a BTS and the geographical area covered by a BTS for purposes of communicating with user equipment (UE), but the terms “cell” and “BTS” are used separately herein (in this patent specification) in instances where the distinction is believed to improve clarity. In graphical representations or maps of cellular networks, such as FIG. 1, cells are typically represented by hexagons for purposes of convenience. During a telephone call, a user can transport the UE anywhere in network 100 where there is coverage, i.e., from one cell to another, and the feature known as handover or handoff ensures that communication is maintained.

Network 100 also includes a number of base station controllers (BSC's), such as BSC 122, each of which is in communication (typically, via a high-speed landline) with a group of the BTS's. Each BSC is, in turn, in communication with the mobile switching center (MSC) 124. Although not shown for purposes of clarity, MSC 124 is in communication with the public switched telephone network (PSTN) so that calls can be routed to and from landline telephones or other cellular networks. The basic functions of MSC 124 and BSC 122 are well-understood in the art and therefore not described herein beyond the extent needed to describe the present invention. Network 100 also includes a serving mobile location center (SMLC) 126, which can be in communication with one or more BSC's in the conventional manner known in the art. The primary purpose of SMLC 126 is to determine the location of each UE. Conventionally, an SMLC is used to determine the geographic location of a UE in the event of an emergency, so that assistance can be dispatched to the user. SMLC 126 can use any suitable means known in the art for determining the location of a UE, such as Assisted GPS (A-GPS), Time Difference of Arrival (TDOA), Angle of Arrival (AOA), etc., or any other means that will occur to persons skilled in the art in view of the teachings herein. In some embodiments of the invention, the SMLC can perform this locating function without assistance from the UE. In other embodiments, the UE can perform this function by determining its own location or assisting in the determination of its location. It is possible to include a GPS receiver or similar location-detection system within the UE itself. In embodiments in which the UE determines its own location, the UE can transmit the location information to the BSC, which in turn transmits it to the SMLC. Alternatively, such embodiments may not include an SMLC, or the SMLC may be used solely for conventional purposes, such as determining the location of a UE in the event of an emergency.

Network 100 also includes a mobile location register (MLR) 128, which is used in accordance with the present invention to receive and store the geographic location of each active UE, store a digitized network map, and determine whether the proper geographic cell is serving the active UE. This is described below in further detail. MLR 128 can obtain the location of each active UE from SMLC 126 via BSC 122. MLR 128 is illustrated for purposes of clarity as a separate entity from BSC 122, but in other embodiments of the invention it can be integrated with BSC 122 or with any other suitable network entity, such as SMLC 126. Also, the term “register” is not intended to convey any specific structure but rather is used for convenience.

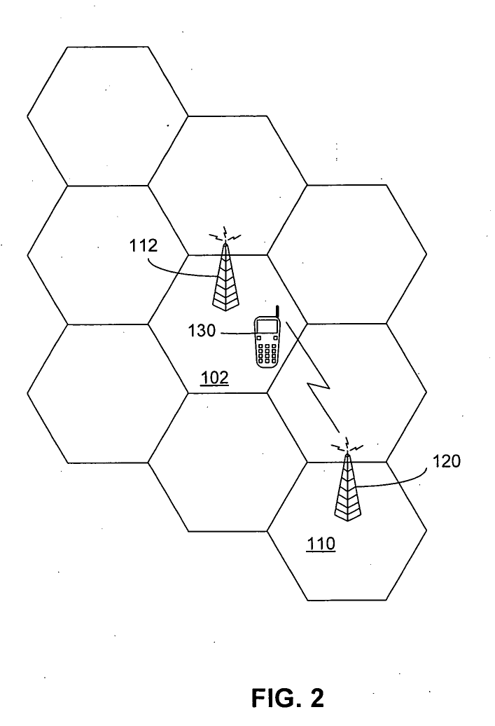

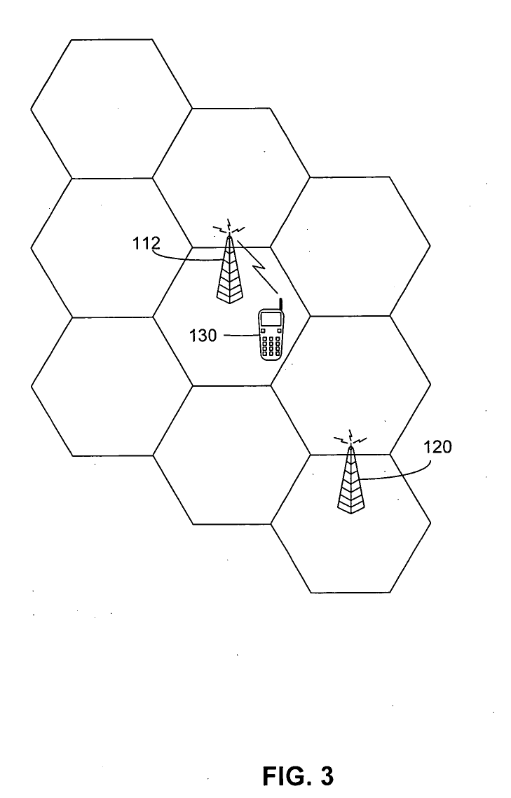

As illustrated in FIG. 2, a mobile handset 130 (sometimes referred to as a cellular telephone), which is a common type of UE, is illustrated as being in use in a telephone call while it is located within cell 102. Note that cell 102 (or, stated another way, the BTS 112 that defines cell 102) is not serving handset 130. That is, the telephone call is not being conducted through BTS 112. Rather, the call is being conducted through BTS 120 (which defines cell 110), even though handset 130 is located within cell 102 and some distance from cell 110. This scenario may occur for a variety of reasons including multipath reflection or other propagation effects arising from terrain features, man-made features such as tunnels, buildings and other structures, and environmental factors. It is possible that handing over handset 130 from cell 110 to cell 102 may improve the call by decreasing the likelihood that the call will be dropped. As known in the art, “dropping” or the loss of a call, occurs when the communication signals between a BTS and the UE it is serving fade or otherwise degrade to the point that the BSC can no longer detect the presence of the UE. It has been discovered in accordance with the present invention that, if the UE is not at that time located in the cell that is serving it, handing over the UE to the cell in which the UE is located (or at least handing it over to a less distant cell) can in some instances decrease the likelihood that the call will be dropped. The result of performing a handover under such circumstances is illustrated in FIG. 3, in which cell 102 is shown serving handset 130.

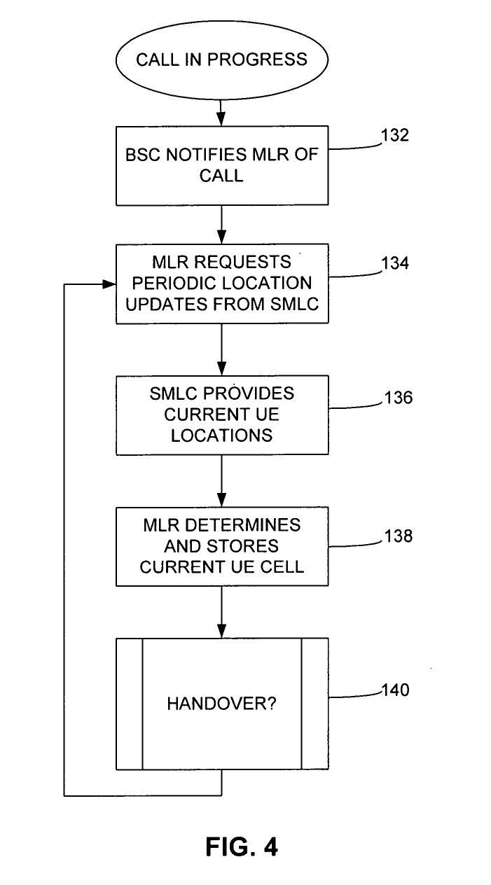

An exemplary communication method in which a UE can be handed over to another cell if the geographic location of the UE suggests that handover will improve communication (e.g., the call is less likely to be dropped) is illustrated in FIG. 4. At step 132, BSC 122 notifies MLR 128 that a call involving a UE has been initiated or a handover has occurred to a call in progress. Step 132 will therefore occur from time to time with respect to the various UE's within cells covered by BSC 122. The notification provided to MLR 128 in step 132 includes information regarding the identification of the current serving cell for the UE. At step 134, MLR 128 requests from SMLC 126 (which it does periodically, such as every few minutes) an update of the locations of all active UE's within cells covered by BSC 122. SMLC 126 responds at step 136. Thus, in the above-described example (see FIG. 2), SMLC 126 provides the geographic location of handset 130 to MLR 128.

At step 138 MLR 128 determines the cell in which each such UE is located and stores the results for use by the handover method as described below. In the illustrated embodiment of the invention, the location information received from SMLC 126 is geographic in nature (e.g., latitude and longitude or some similar form or coordinates or references) and independent of the cellular network. Therefore, MLR 128 is required to determine the cell to which the geographic location corresponds. For this purpose, MLR 128 can include a representation of a map (e.g., stored in digital memory), such as the standard array of hexagons, which relates each cell to some suitable geographic location system, such as latitude and longitude. For example, the map data can include the latitudes and longitudes of points on the boundary or perimeter of each hexagon, such as its vertices. Using that stored information and performing suitable computations or comparisons, MLR 128 can determine the cell in which a UE is located. Storing the locations of points on the hexagon perimeters is intended only as an example, and other ways of representing such a network map in memory in a manner that facilitates determining the cell in which a UE is located will occur readily to persons skilled in the art to which the invention relates.

At step 140 BSC 122 determines, at least partly in response to the geographic location of the UE, whether to hand over that UE to a different cell. That is, the result is based on the geographic location of the UE and may be based on additional factors or inputs as well, such as those that are used conventionally in the art to determine whether to hand over a UE to a different cell. Conventionally, a BSC includes a processor system with suitable hardware and software logic that performs a handover routine to determine whether to hand over a UE based solely upon signal measurements. Each BTS that receives signals from a UE relays those signals or signals derived from them to its BSC, which elects one of those BTS's, based upon signal strength and quality, as the one to serve the UE. If the elected cell is not the then-serving cell, the handover routine signals the BSC to hand over the UE to the elected cell.

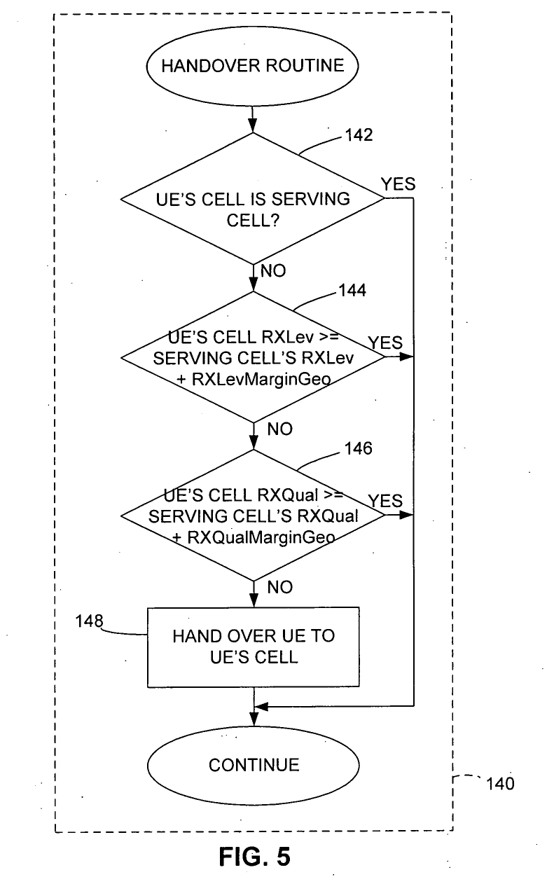

An example of such a handover routine that can be performed by BSC 122 in one embodiment of the invention is illustrated in FIG. 5. At step 142 BSC 122 determines whether the cell in which the UE is located is the cell that is serving the UE. If it is the serving cell, then the call continues without performing handover, as the cell in which the UE is located is most likely the best cell to serve the UE. If it is not the serving cell, then at step 144 BSC 122 determines if the strength or level (“RXLev”) of the signals received from the UE by the cell in which the UE is located is greater than or equal to the RXLev of the signals received from the UE by the serving cell plus a predetermined margin (“RXLevMarginGeo”). If the RXLev of the signals received from the UE by the cell in which the UE is located is greater than or equal to this quantity, then the call continues without performing handover, as the cell in which the UE is located is receiving a very strong signal and is thus most likely the best cell to serve the UE. However, if the RXLev of the signals received from the UE by the cell in which the UE is located is less than that quantity, then at step 146 BSC 122 determines if the quality (“RXQual”) of the signals received from the UE by the cell in which the UE is located is greater than or equal to the RXLQual of the signals received from the UE by the serving cell plus a predetermined margin (“RXQualMarginGeo”). If the RXQual of the signals received from the UE by the cell in which the UE is located is greater than or equal to this quantity, then the call continues without performing handover, as the cell in which the UE is located is receiving a very high quality signal and is thus most likely the best cell to serve the UE. However, if the RXQual of the signals received from the UE by the cell in which the UE is located is less than that quantity, then at step 148 the handover routine signals BSC 122 to hand over the UE to the cell in which the UE is located. The handover itself is performed in the conventional manner and is therefore not described herein. With reference again to the example illustrated in FIGS. 2 and 3, it can be seen that handset 130 will be handed off from more distant cell 110 to the cell 102 in which it is located unless the peculiarities of signal propagation result in the signals received from the UE by cell 110 being either especially strong or of especially high quality (i.e., exceeding the quality or strength of those signals received by cell 102 by predetermined margins).

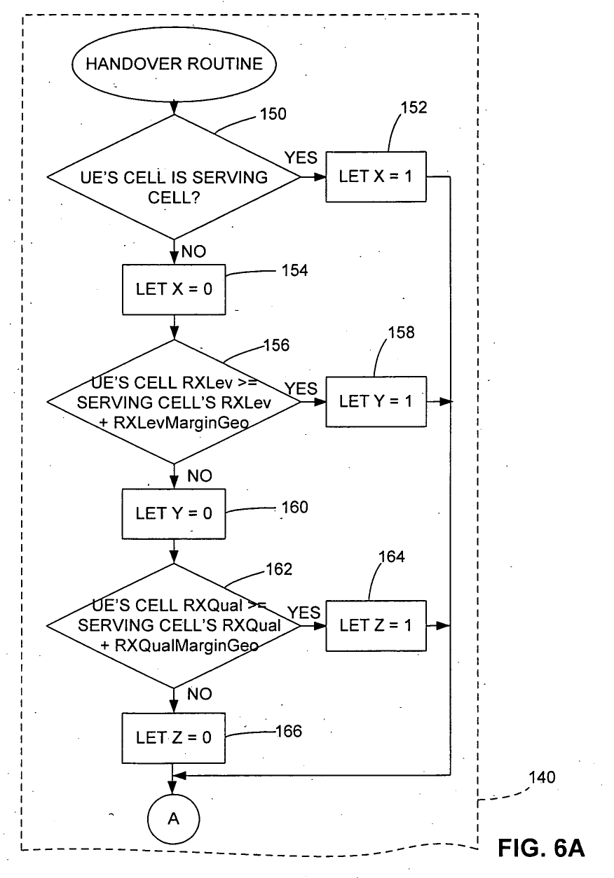

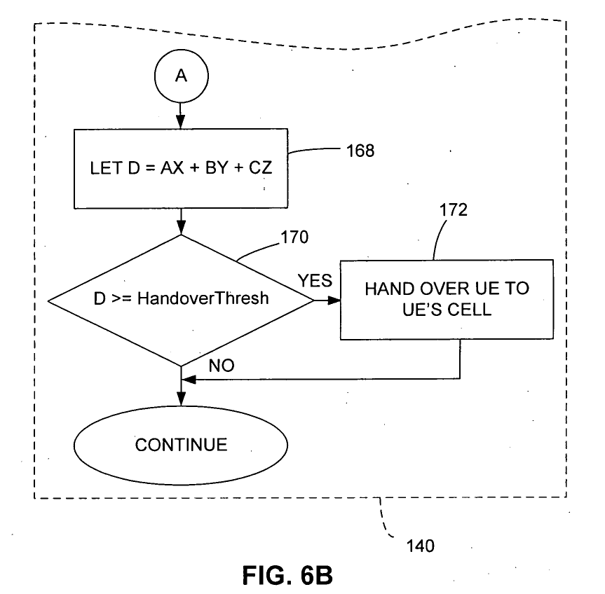

Another example of a handover routine that can be performed by BSC 122 in another embodiment of the invention is illustrated in FIGS. 6A-B. In this embodiment, the selection algorithm is weighted to favor handing off to the cell in which the UE is located unless the signals received by the more distant serving cell are either especially strong or of especially high quality. The result is similar to that of the embodiment described above with regard to FIG. 5. In still other embodiments (not shown), handoff algorithms can be weighted in other manners. For example, a conventional handover algorithm, such as MAHO, can be modified in accordance with the present invention to more heavily weight the cell in which the UE is located than a more distant cell.

At step 150 BSC 122 determines whether the cell in which the UE is located is the cell that is serving the UE. If it is the serving cell, then a quantity X, which is used in a computation described below, is given the value 1 at step 152. If it is not the serving cell, then X is given the value 0 at step 154, and the routine continues at step 156. At step 156 BSC 122 determines if the RXLev of the signals received from the UE by the cell in which the UE is located is greater than or equal to the RXLev of the signals received from the UE by the serving cell plus RXLevMarginGeo. If the RXLev of the signals received from the UE by the cell in which the UE is located is greater than or equal to this quantity, then a quantity Y, which is used in the computation described below, is given the value 1 at step 158. If it is not, then Y is given the value 0 at step 160, and the routine continues at step 162. At step 162 BSC 122 determines if the RXQual of the signals received from the UE by the cell in which the UE is located is greater than or equal to the RXQual of the signals received from the UE by the serving cell plus RXQualMarginGeo. If the RXQual of the signals received from the UE by the cell in which the UE is located is greater than or equal to this quantity, then a quantity Z, which is used in the computation described below, is given the value 1 at step 164. If it is not, then Z is given the value 0 at step 166, and the routine continues at step 168.

At step 168 BSC 122 computes the quantity AX+BY+CZ, which A, B and C are predetermined weights or constants. For example, A, B and C can be 60, 30 and 10, respectively. In another example, they can be 40, 30 and 30, respectively. These numbers are only intended as examples, and persons skilled in the art will readily be capable of selecting suitable weights in this algorithm and others. At step 170 BSC 122 determines if the resulting quantity D is greater than or equal to a predetermined threshold (“HandoverThresh”). If D exceeds HandoverThresh, then at step 172 the handover routine signals BSC 122 to hand over the UE to the cell in which the UE is located. It is expected that persons skilled in the art will readily be capable of selecting suitable weights and thresholds. The handover itself is performed in the conventional manner and is therefore not described herein. As noted above, the result of the algorithm in this embodiment is similar to the result of that of the embodiment described above with regard to FIG. 5. That is, a UE that is not located in the cell that is serving it will be handed off to the cell in which it is located unless the peculiarities of signal propagation result in the signals received from the UE by the more distant cell being strong or of high quality. The weighting factors determine the extent to which strength and quality need to outweigh proximity for handover to occur.

As described above, in accordance with the present invention the geographic location of a voice handset, wireless data device or other UE is determined, and handover is performed at least in part in response to the geographic location of the UE. For example, in the above-described embodiments of the invention, handover is performed partly in response to the location of the UE and partly in response to measures of signal strength and quality. To do this, the handover algorithm or method can hand over the UE to the cell in which it is located unless the signals received from the UE by the serving cell are better than those received from the UE by the serving cell by predetermined margins, as in the method illustrated in FIG. 5. Alternatively, the handover algorithm or method can assign weights to factors such as whether the UE is located in the serving cell, the strength of the signals received from the UE by the serving cell, and the quality of the signals received from the UE by the serving cell, and determine whether to hand over the UE depending upon the weighted factors. Still other weighted selection algorithms will occur readily to persons skilled in the art in view of these teachings.

It will be apparent to those skilled in the art that various modifications and variations can be made to this invention without departing from the spirit or scope of the invention. Thus, it is intended that the present invention covers the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. A communication method, comprising the steps of:
determining a geographic location of a user equipment (UE) operating in a cellular communication network; and
selecting a cell to which to hand over the UE at least partly in response to the geographic location of the UE.

2. The communication method as claimed in claim 1, wherein the selecting step comprises selecting a cell to which to hand over the UE partly in response to the geographic location of the UE and partly in response to signal measurements.

3. The communication method as claimed in claim 2, wherein the selecting step comprises weighting a selection algorithm to favor a cell nearer to the UE over a cell farther from the UE.

4. The communication method as claimed in claim 3, wherein the selecting step comprises weighting the selection algorithm to favor a cell in which the UE is located over a cell in which the UE is not located.

5. The communication method as claimed in claim 1, wherein the determining step comprises:
storing information representing a geographic cell map; and
comparing information representing the location of the UE with the information representing a geographic cell map to identify the cell within which the UE is located.

6. A communication system, comprising:
locating means for determining a geographic location of a user equipment (UE) operating in a cellular communication network; and
handover means for selecting a cell to which to hand over the UE at least partly in response to the geographic location of the UE.

7. The communication system as claimed in claim 6, wherein the handover means selects a cell to which to hand over the UE partly in response to the geographic location of the UE and partly in response to signal measurements.

8. The communication system as claimed in claim 7, wherein the handover means comprises a processor system for performing a weighted selection algorithm favoring a cell nearer to the UE over a cell farther from the UE.

9. The communication system as claimed in claim 8, wherein the handover means comprises a processor system for performing a weighted selection algorithm favoring a cell in which the UE is located over a cell in which the UE is not located.

10. The communication system as claimed in claim 6, wherein the locating means comprises:
storage means for storing information representing a geographic cell map; and
comparison means for comparing information representing the location of the UE with the information representing a geographic cell map to identify the cell within which the UE is located.

11. A communication system, comprising:
a location detection system for determining a geographic location of a user equipment (UE) operating in a cellular communication network; and
a network entity for selecting a cell to which to hand over the UE at least partly in response to the geographic location of the UE.

12. The communication system as claimed in claim 11, wherein the network entity selects a cell to which to hand over the UE partly in response to the geographic location of the UE and partly in response to signal measurements.

13. The communication system as claimed in claim 12, wherein the network entity comprises processor system for performing a weighted selection algorithm favoring a cell nearer to the UE over a cell farther from the UE.

14. The communication system as claimed in claim 13, wherein the network entity comprises a processor for performing a weighted selection algorithm favoring a cell in which the UE is located over a cell in which the UE is not located.

15. The communication system as claimed in claim 11, wherein the location detection system comprises:
a memory for storing information representing a geographic cell map; and
a processor system for comparing information representing the location of the UE with the information representing a geographic cell map to identify the cell within which the UE is located.

16. A communication method, comprising the steps of:
measuring signals communicated between a user equipment (UE) operating in a cellular communication network and one or more base transceiver stations; and
selecting a cell to which to hand over the UE partly in response to signal measurements and partly in response to at least one other information factor.

17. The communication method as claimed in claim 16, wherein the other information factor comprises a geographic location of the UE.

18. The communication method as claimed in claim 17, wherein the selecting step comprises weighting a selection algorithm to favor a cell nearer to the UE over a cell farther from the UE.
